(19) United States
(12) Patent Application Publication
(10) Pub. No.: US 2004/0014837 A1
(43) Pub. Date: Jan. 22, 2004

(54) Dimethylamine/ester adducts and their use in polymerizable compositions

(76) Inventors: Jean-Claude Vanovervelt, Warchin (BE); Vincent Stone, Brussels (BE)

Correspondence Address: WENDEROTH, LIND & PONACK, L.L.P., 2033 K STREET N. W., SUITE 800, WASHINGTON, DC, 20006-1021, US

(21) Appl. No.: 10/399,533

(22) PCT Filed: Oct. 15, 2001
(86) PCT No.: PCT/EP01/11895

(30) Foreign Application Priority Data
Oct. 20, 2000 (EP) 00122859.2

(51) Int. Cl. C08J 3/28

(52) U.S. Cl. 522/153

(57) ABSTRACT

There is described an amine/ester adduct formed between dimethylamine (DMA) and at least one optionally substituted α,β unsaturated ester obtained or obtainable by reacting a suitable acrylic or methacrylic acid with a suitable alcohol or polyol, chartacterised that said adduct has a level of animation above about 75%. The adduct may be used as a co-activator and/or reactive diluent for UV curable, polymerisable formulations. A process for preparing the adduct is also described as are polymers made therefrom. The adduct and polymers made therefrom are preferably substantially free of free-DMA and/or odour free.

The present invention relates to adducts of amines and α,β-unsaturated esters and improved methods for producing them.

The reaction product(s) of a secondary amine with an optionally substituted and/or multifunctional acrylate (also referred to herein as amine/acrylate adducts) are known as useful co-activators for UV initiated polymerisation of monomers such as acrylates. These adducts have the advantages of free amine activators (such as good reactivity at low concentration) with the additional advantages of a good pot-life and/or no migration.

Adducts formed from the reaction of diethylamine (DEA) with a multifunctional acrylate, such as tripropylene glycol diacrylate (TPGDA) (1 eq:1 eq), have been widely available for over ten years (for example a TPGDA/DEA adducts is available commercially from UCB Chemicals under the trade designation “P115”).

However for adducts formed with DEA if is often very difficult to obtain products which are fully aminated. Thus it is believed that some commercially available DEA/acrylate adducts may in fact only be partially aminated (typically up to 80% amination). This difficulty of obtaining complete amination with DEA may be due to the slow and incomplete Michael addition of DEA on acrylates even after hours of maturation just below the boiling point of DEA. A direct consequence of incomplete amination is the necessity to remove any residual DEA, which increases the batch time and requires costly emission control. Yet despite removal of DEA, incompletely aminated products may still exhibit odor problems due to the continued presence of trace amounts of unremoved DEA. Many studies have shown how subtle differences in processing conditions and/or storage conditions of the final product may affect the residual amine content in an DEA/acrylate adduct and hence its odor properties.

Thus it is desirable to find improved amine acrylate adducts and/or processes for making them which solve some or all of the problems described herein.

The 1,4 addition of secondary amines on α,β-unsaturated esters can be represented by the following two step reaction scheme in which the secondary amine undergoes a Michael addition to the α,β-unsaturated esters to protonate the oxygen, followed by a enol-keto tautomerization. The reaction scheme shows addition to a non polymeric ester but it will be appreciated that polymeric and/or multifunctional esters could also be used in which case the addition products (adducts) may comprise a mixture of different products.

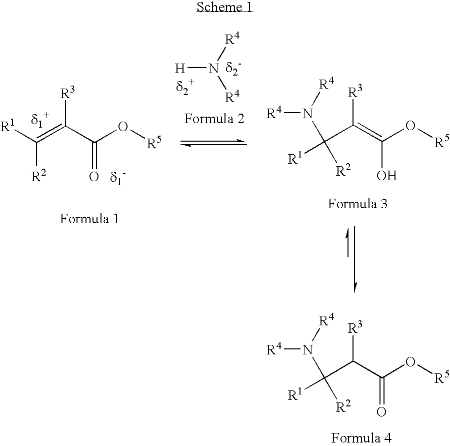

In the above Formulae 1 to 4, in Scheme 1, the substituents are as follows:

α,β-Unsaturated acids and esters of Formula 1 comprise R¹ to R⁵ which generally each independently represent H or optionally substituted organo groups; preferably represent H or C₁₋₂₀hydrocarbo; more preferably H or C₁₋₈alkyl; and most preferably H or C₁₋₄alkyl. Conveniently R⁵ is other than H preferably methyl. In Formula 1 above, when R³ is H, then Formula 1 (and/or derivatives thereof) represent a (mono) acrylate; when R³ is methyl then Formula 1 (and/or derivatives thereof) represents a (mono) methacrylate; and when one of R¹ or R² is methyl and R³ is H, then Formula 1 (and/or derivatives thereof) represents a (mono) crotonate, when R¹ and R² are both methyl then Formula 1 (and/or derivatives thereof) represent a crotonate.

Secondary amines of Formula 2 comprise each R⁴ on the nitrogen which may be the same or different but are preferably the same. Generally R⁴ represents optionally substituted organo, preferably C₁₋₂₀hydrocarbo, more preferably C₁₋₈alkyl and most preferably C₁₋₄alkyl. In Formula 2 above, when both R⁴ are ethyl, then Formula 2 represents diethylamine also denoted herein as “DEA”; when both R⁴ are methyl, then Formula 2 represents dimethylamine also denoted herein as “DMA”. Conventional amine/acrylate adducts are those where R⁴ is ethyl.

In Formulae 3 and 4 above, R¹ to R⁵ are as represented in Formulae 1 and 2 herein. The above reaction scheme can also be used to prepare a compound or polymer represented by Formula 5

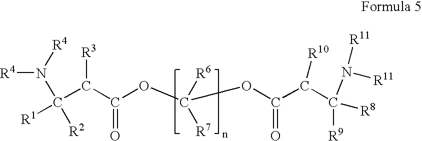

in which R¹ to R⁵ are as represented in Formulae 1 to 4;

R⁸ to R¹¹ are each independently are as represented for R¹ to R⁵ respectively and may be the same or different (optionally the same) as the corresponding R¹ to R⁵ group; and R⁶ and R⁷ independently represent H or optionally substituted organo groups; preferably represent H or C₁₋₂₀hydrocarbo; more preferably H or C₁₋₈alkyl; and most preferably H or C₁₋₄alkyl;

n is an integer from 1 to 10.

Independently in each repeat unit (where n is 2 or more) R⁶ and/or R⁷ may also represent a moiety of Formula 5a so that Formula 5 may represent a tri (or greater) polyacrylate:

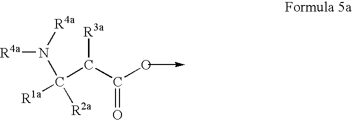

where R^{1a} to R^{5a} independently denote groups selected from any of those as given for the corresponding R¹ to R⁵ groups represented in Formulae 1 to 4; and the arrow denotes the point of attachment to the repeat unit in Formula 5.

When both R³ and R¹⁰ are H then Formula 5 represents a polyacrylate when one or more of R⁶ and/or R⁷ are a moiety of Formula 5a (in which R^{3a} is also H); and otherwise a diacrylate.

When both R³ and R¹⁰ are methyl then Formula 5 represents a polymethacrylate when one or more of R⁶ and/or R⁷ are a moiety of Formula 5a (in which R^{3a} is also methyl); and otherwise a dimethacrylate.

Preferably in Formula 5 none of the substituents are phenyl and the compound or polymer of Formula 5 is other than a crotonate, preferably a (poly)acrylate or (poly)methacrylate.

Other amines such as DMA have not been previously used in preference to DEA to make commercial adducts because they were not readily available in industrial quantities, were expensive and/or were difficult to use and therefore were not considered advantageous. The applicant has surprisingly discovered that nevertheless DMA can be used in improved processes to produce adducts of DMA and α,β-unsaturated esters (such as acrylates) which have improved properties.

DMA is conventionally available as an aqueous solution (available commercially from UCB Chemicals under the trade designation “DMA60”) which is 60% DMA by weight dissolved in water. Use of 60% DMA (aq) requires an additional stripping/concentration step to remove the water at the end of the process.

An alternative source of DMA is to use gaseous DMA (referred to herein as g-DMA). Use of g-DMA requires specialized and costly equipment for processes conducted under high-pressure.

Recently a product in which 63% DMA by weight is dissolved liquid CO₂ has become available which is an easy-to-handle water-free source of DMA. It is available commercially under the trade designations “Dimcarb” or “Dimasol 63” from UCB Chemicals.

“Dimcarb” is a liquid having a boiling point of about 60° C. at atmospheric pressure, which may be considered an addition product of DMA and CO₂ as they form weak complexes when put together. However due to rather loose bonds existing between DMA and CO₂, “Dimcarb” may also be considered as a solution of DMA in CO₂ as it has been reported to behave like free DMA in most chemical reactions. “Dimcarb” can also be denoted by the terms “dimethylammonium dimethylcarbamate” and/or “dimethylamine and dimethylcarbamic acid compound or complex”. Its composition may not generally comply with the theoretical stoichiometry of dimethylammonium dimethylcarbamate, which should comprise 2 moles of DMA for every mole of CO₂. For example when prepared as described in Example 1 of WO 97/06134, “Dimcarb” may comprise 1.7 moles of DMA for every mole of CO₂. One other major advantage of Dimcarb is that one can very easily get rid of the “solvent”; as no special exhaust treatment is required to emit CO₂.

A detailed description of the characteristics of “Dimcarb” is given in the article by W. Stroth et al., “Der Dimethylamin-Kohlendioxid-Komplex Dimcarb und sein präparative Verwendung” [the dimethylamine-carbon dioxide dimcarb and its preparative use”] (Chemiker Zeitung, 113 (9), (1989), 261-271).

CAS 120/133969r is an abstract of a paper which describes the synthesis of β-amino acid derivatives via reductive amination of unsaturated carboxylic acid derivatives in dimcarb. However on reading the full article (Hess et al;, Humboldt Univ; Pharmazie, 48(8) (1993), 591-597) it is clear that the paper only relates to derivatives which are phenyl substituted and/or crotonates. The paper is concerned with regioselective aspects of this reaction and thus teaches away from other unsaturated esters with different structures such as acrylates or methacrylates, which are not described specifically therein. In this reference excess amine is used which also teaches away from some aspects of the present invention.

It has surprisingly been discovered that certain acrylate and methacrylate adducts formed with DMA are advantageous to an unexpected extent. All three sources of DMA [(g-DMA, “Dimcarb” and “DMA60”] described above have been tested herein, although it will be appreciated that any suitable source of DMA may used to prepare the adducts of the present invention.

Therefore broadly in accordance with the present invention there is provided an adduct formed between dimethylamine (DMA) and at least one optionally substituted α,β unsaturated ester obtained or obtainable by reacting a suitable acrylic or methacrylic acid with a suitable alcohol or polyol, characterized that said adduct has a level of amination above about 75%. Preferably the adduct is formed between a substantially stiochiometric ratio of DMA and the ester.

In alternative aspect of the invention provides an amine/ester adduct formed between a substantially stiochiometric ratio of dimethylamine (DMA) and at least one optionally substituted α,β unsaturated ester obtained or obtainable by reacting a suitable crotonoic acid with a suitable alcohol or polyol, characterised that said adduct has a level of amination above about 75%.

Adducts of the present invention may exhibit increased radiation sensitivity.

Without wishing to be bound by any mechanism it is believed that the higher nucleophilicity (δ₂-) and the lower sterical hindrance for DMA (R⁴═CH₃), compared to DEA (R⁴═CH₂—CH₃) may lead DMA to add faster to an (meth)acrylate than DEA at a given temperature. This could result in quantitatively improved conversion rates at lower temperatures within affordable reaction times. Being exothermic, this equilibrated addition is indeed less and less thermodynamically favoured with increasing temperatures.

Preferred esters are selected from the group consisting of: trimethylolpropane triacrylate (TMPTA), tripropylene glycol diacrylate (TPGDA), tetraethylene glycol diacrylate, 1,6-hexanediol diacrylate (HDDA), 1,3-butylene glycol diacrylate, 2-phenoxyethyl acrylate, trimethylolpropane trimethacrylate, polyethylene glycol dimethacrylate, tetraethylene glycol dimethacrylate; 1,3-butylene glycol dimethacrylate; polyether acrylates [such as ethoxylated trimethylolpropane triacrylate (such as that available commercially from UCB under the trade mark Ebecryl 160) and propoxylated glycerol triacrylate (such as that available commercially from UCB under the trade name OTA 480)]; polypropylene glycol diacrylates (such as those of two different chain lengths: PPG265DA and PPG425DA); ethoxylated/propoxylated penthaerythritol tetracrylate (such as that available commercially from UCB under the trade mark Ebecryl 160); dipentaerythritol hexaacrylate (DPHA) octyl/decyl acrylate, cyclic trimethylolpropane formal acrylate, isobornyl acrylate, dipropylene glycol diacrylate, tricyclodecane dimethanol diacrylate, ethoxylated trimethylolpropane triacrylate, propoxylated glycerol triacrylate, polypropylene glycol diacrylates, ditrimethylolpropane tetracrylate, ethoxylated/propoxylated pentaerythrytol tetracrylate, pentaerythrytol tetracrylate, dipentaerythritol hexaacrylate, octyl/decyl methacrylate, cyclic trimethylolpropane formal methacrylate, isobornyl methacrylate, dipropylene glycol dimethacrylate, 1,6-hexanediol dimethacrylate, 2-phenoxyethyl methacrylate, tricyclodecane dimethanol dimethacrylate, ethoxylated trimethylolpropane trimethacrylate, propoxylated glycerol trimethacrylate, polypropylene glycol dimethacrylates, ditrimethylolpropane tetramethacrylate, ethoxylated/propoxylated pentaerythrytol tetracrylate, pentaerythrytol tetramethacrylate, dipentaerythritol hexamethacrylate and effective combinations and/or mixtures thereof.

Preferred alcohol(s) or polyol(s) are selected from the group consisting of: isoborneol, isoborneol, trimethylolpropane, cyclic trimethylolpropane formal, ditrimethylolpropane, dipropylene glycol, tricyclodecane dimethanol, ethoxylated trimethylolpropane, propoxylated glycerol, pentaerythrytol, ethoxylated/propoxylated pentaerythrytol, dipentaerythritol and effective combinations and/or mixtures thereof.

A further aspect of the present invention comprises a process for preparing a substantially anhydrous, substantially amine free adduct comprising the steps of:

(a) reacting

(i) a source of dimethylamine (DMA) with

(ii) at least one optionally substituted α,β unsaturated ester obtained or obtainable by reacting a suitable acrylic or methacrylic acid with a suitable alcohol or polyol,

until amination is substantially complete; and

(b) treating the product(s) of step (a) to obtain an adduct substantially free of amine and/or water.

A still further aspect of the present invention comprises a polymer obtained and/or obtainable by the radiation initiated polymerisation of at least one suitable polymer precursor, optional reactive diluent and an adduct of the present invention. Preferred examples of polymer precursors are selected from the group consisting of: polyester acrylate oligomers, epoxy acrylate oligomers, urethane acrylate oligomers; and effective combinations and/or mixtures thereof.

Preferred examples of reactive diluents are selected from the group consisting of: octyl/decyl acrylate, isobornyl acrylate, cyclic trimethylolpropane formal acrylate, 2-phenoxyethyl acrylate, N-butyl 2-(acryloxoloxy) ethyl carbamate, 1,6-hexanediol diacrylate, dipropylene glycol diacrylate, tripropylene glycol diacrylate, tetrapropylene glycol diacrylate, trimethylolpropane triacrylate, pentaerythrytol tetracrylate, propoxylated glycerol triacrylate, ethoxylated trimethylolpropane triacrylate, ethoxylated/propoxylated pentaerythrytol tetracrylate, dipentaerythritol hexamethacrylate and effective combinations and/or mixtures thereof.

Without wishing to be bound by any mechanism it is believed that adducts of the present invention may act as an activator for polymerisation (optionally in the presence of other polymer precursors and/or reactive diluents) by limiting, suppressing and/or inhibiting the amount and/or reactivity of the oxygen present for example to increase the rate of radiation induced polymerisation.

Broadly other aspects of the present invention may comprise:

A formulation which is UV curable and/or polymerisable and which comprises an adduct of the present invention.

Use of an adduct of the present invention in a method of preparing a polymer as described herein.

Use of an adduct of the present invention as an activator and/or reactive diluent for radiation induced polymerisation.

A substrate and/or article coated with and/or comprising an adduct, polymer and/or formulation of the present invention.

Further aspects of the invention and preferred features thereof are described herein and/or in the claims.

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other re present a sulphamoyl group). Preferred optional substituents comprise: carboxy, sulpho, hydroxy, amino, mercapto, cyano, methyl and/or methoxy.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other atoms (denoted herein as heteroatoms). Organic groups may comprise organoheteryl groups (also known as organoelement groups) which comprise univalent groups containing carbon, which are thus organic, but which have their free valence at an atom other than carbon (for example organothio groups).

Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the heteroatom(s) in an organic group may be selected from one or more of: hydrogen, halo, phosphorus, nitrogen, oxygen and/or sulphur, more preferably from hydrogen, nitrogen, oxygen and/or sulphur.

The term ‘hydrocarbo group’ as used herein is a sub-set of a organic group and denotes any univalent or multivalent moiety (optionally attached to one or more other moieties) which consists of one or more hydrogen atoms and one or more carbon atoms. Hydrocarbo groups may comprise one or more hydrocarbyl, hydrocarbylene; hydrocarbylidene, and/or hydrocarbylidyne groups. Hydrocarbyl groups comprise univalent groups formed by removing a hydrogen atom from a hydrocarbon. Hydrocarbylene groups comprise divalent groups formed by removing two hydrogen atoms from a hydrocarbon the free valencies of which are not engaged in a double bond. Hydrocarbylidene groups comprise divalent groups (represented by “R₂C═”) formed by removing two hydrogen atoms from the same carbon atom of a hydrocarbon, the free valencies of which are engaged in a double bond; Hydrocarbylidyne groups comprise trivalent groups (represented by “RC≡”), formed by removing three hydrogen atoms from the same carbon atom of a hydrocarbon the free valencies of which are engaged in a triple bond. Hydrocarbo groups may also comprise any saturated, unsaturated double and/or triple bonds (e.g. alkenyl, and/or alkynyl respectively) and/or aromatic groups (e.g. aryl) and where indicated may be substituted with other functional groups. “R” used above independently denotes H and/or any hydrocarbyl group.

Most preferably organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group):

The term ‘alkyl’ or its equivalent (e.g. ‘alk’) as used herein may be readily replaced, where appropriate and unless the context clearly indicates otherwise, by terms encompassing any other hydrocarbo group such as those described herein.

Any substituent, group or moiety mentioned herein refers to a monovalent species unless otherwise stated or the context clearly indicates otherwise (e.g. an alkylene moiety may comprise a bivalent group linked to two other moieties). A group which comprises a chain of three or more atoms signifies a group in which the chain wholly or in part may be linear, branched and/or form a ring (including spiro and/or fused rings). The total number of certain atoms is specified for certain substituents for example C₁₋ₘ organo, signifies an organic group having from 1 to m carbon atoms. In any of the formulae herein if one or more ring substituents are not indicated as attached to any particular atom on the ring, the substituent may replace any hydrogen atom attached to a ring atom and may be located at any available position on the ring which is chemically suitable.

Preferably any of organic groups listed above comprise from 1 to 36 carbon atoms, more preferably from 1 to 18. It is particularly preferred that the number of carbon atoms in an organic group is from 1 to 10 inclusive.

Unless the context clearly indicates otherwise, as used herein plural forms of the terms herein are to be construed as including the singular form and vice versa.

The term ‘effective’ (for example with reference to the process, uses, products, materials, compounds, monomers, oligomers, polymer precursors and/or polymers of and/or relating to the present invention) will be understood to refer to those ingredients which if used in the correct manner provide the required properties to the material, compound, composition, monomer, oligomer, polymer precursor and/or polymer to which they are added and/or incorporated in any one or more of the uses and/or applications described herein. As used herein the term “suitable” denotes that a functional group is compatible with producing an effective product.

The substituents on the repeating unit may be selected to improve the compatibility of the materials with the polymers and/or resins in which they may be formulated. Thus, the size and length of the substituents may be selected to optimise the physical entanglement or interlocation with the resin or they may or may not comprise other reactive entities capable of chemically reacting and/or cross-linking with such other resins.

Certain moieties, species, groups, repeat units, compounds, oligomers, polymers, materials, mixtures, compositions and/or formulations which comprise some or all of the invention as described herein may exist as one or more stereoisomers (such as enantiomers [such as R/S forms], diastereoisomers, geometric isomers [such as E/Z isomers], tautomers [such as enol/keto forms] and/or conformers), salts, zwitterions, complexes (such as chelates, clathrates, crown compounds, cyptands/cryptades, inclusion compounds, intercalation compounds, interstitial compounds, ligand complexes, non-stoichiometric complexes, organometallic complexes, π-adducts, solvates and/or hydrates); isotopically substituted forms, polymeric configurations [such as homo or copolymers, random, graft or block polymers, linear polymers, branched polymers (e.g. star and/or side branched polymers), hyperbranched polymers and/or dendritic macromolecules (such as those of the type described in WO 93/17060), cross-linked and/or networked polymers, polymers obtainable from di and/or tri-valent repeat units, dendrimers, polymers of different tacticity (e.g. isotactic, syndiotactic or atactic polymers)]; polymorphs [such as interstitial forms, crystalline forms, amorphous forms, phases and/or solid solutions] combinations thereof where possible and/or mixtures thereof. The present invention comprises all such forms which are effective for example in the uses described herein.

It is appreciated that certain features of the invention, which are for clarity described in the context of separate embodiments may also be provided in combination in a single embodiment. Conversely various features of the invention, which are for brevity, described in the context of a single embodiment, may also be provided separately or in any suitable sub-combination.

The term “comprising” as used herein will be understood to mean that the list following is non-exhaustive and may or may not include any other additional suitable items, for example one or more further feature(s), component(s), ingredient(s) and/or substituent(s) as appropriate.

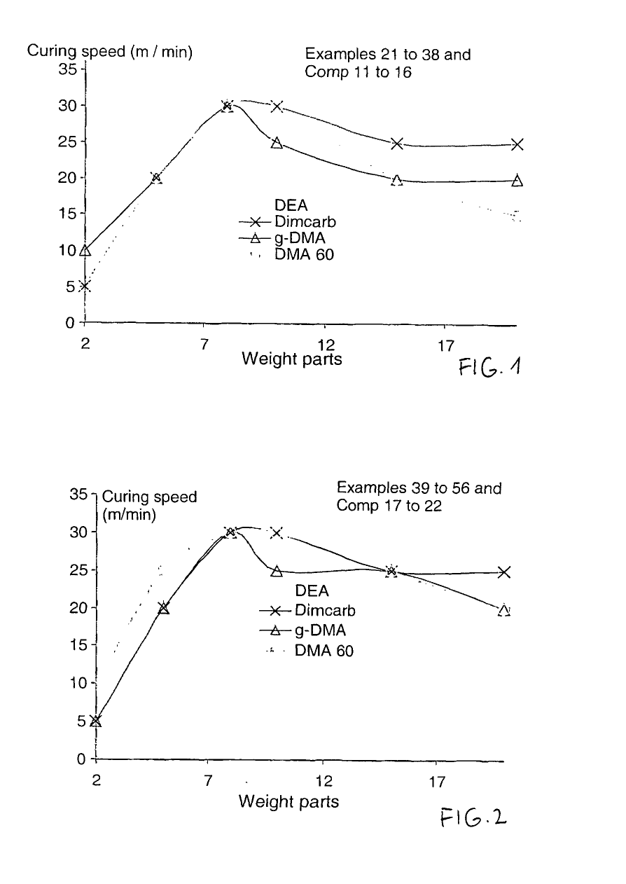

FIGS. 1 to 3 are plots of cure speed for various formulations with different types and amounts of acrylates as further described in Examples herein (such Examples 21 to 74); and

FIG. 4 is a schematic diagram of the pressure vessels used in Generic Example II to prepare adducts using g-DMA.

### EXAMPLES

The invention will now be illustrated by the following non-limiting examples.

The following generic processes (Comp A and Examples I to III) were used herein to prepare adducts of amines and those specific α,β-unsaturated esters specified herein, using as the amine, DEA and various the DMA sources given below.

### Generic Comp A

Amination of α,β-Unsaturated Esters with DEA

A reaction vessel was charged with the α,β-unsaturated ester (1 eq) and trisnonylphenylphosphite (1% w/w). The DEA (1.1 eq) was added dropwise so as to maintain temperature of the reaction mixture below 40° C. Once the addition was completed, the mixture was heated to 50° C. and then it was left to maturate at this temperature until there was no change in amine content. A reduced pressure of 100 mmHg at this temperature was applied to the reaction vessel to decrease the DEA concentration in the mixture to below 200 ppm, which was confirmed by analysing a sample.

### Generic Example I

Amination of α,β-Unsaturated Esters with Dimcarb

A reaction vessel was charged with the α,β-unsaturated ester (1 eq) and trisnonylphenylphosphite (1% w/w). The Dimcarb (1.1 eq) was added dropwise so as to maintain temperature of the reaction mixture below 40° C. Once the addition was completed, a reduced pressure of 100 mmHg was applied to the reaction vessel at room temperature with strong agitation for 30 min in order to remove residual CO₂. That the mixture was substantially free of both free-DMA and CO₂ was confirmed by analysing a sample.

### Generic Example II

Amination of α,β-Unsaturated Esters with g-DMA

Amination under pressure was carried out using the following experimental set-up (refer to FIG. 4 herein). A one litre double-walled reaction vessel was used equipped with temperature (TI) and pressure indicators (PI), a safety valve and an sampling outlet. The vessel was charged with the α,β-unsaturated ester (1 eq) and trisnonylphenylphosphite (1% w/w). The 500 ml pressure vessel was filled with g-DMA (1.1 eq). The supply circuit from the pressure vessel to the reaction vessel was pressurized to 20 bar and the back pressure was set to 15 bar with the safety valve so as to maintain a pressure of 5 bar in the reaction vessel. The contents of the reaction vessel were stirred at high speed and the g-DMA was added from the pressure vessel at a flow rate of 180 g/h with the aid of the valve (V2) and a mass flow meter (MFM). The temperature of the reaction vessel was maintained below 40° C. by cooling the double envelope of the reaction vessel with a water/glycol mixture. Once elimination was complete, the pressure was reduced to atmospheric and the system was flushed with nitrogen. The product was cooled down to room temperature and transferred to a glass container. A sample of the product mixture was analysed and if the DMA residual content was too high, the mixture was subjected to a reduced pressure of 100 mmHg at 50° C. with high agitation to withdraw residual g-DMA.

### Generic Example III

Amination of α,β-Unsaturated Esters with DMA60

A reaction vessel was charged with the α,β-unsaturated ester (1 eq) and trisnonylphenylphosphite (1% w/w) and the vessel was heated to 40° C. The DMA40 (1.1 eq) was added dropwise so as to maintain temperature of the reaction mixture below 45° C. If reaction mixture became hazy (emulsion-like), the temperature was increased until mixture turned translucent. A reduced pressure of 100 mmHg was applied to the reaction vessel at 50° C. with strong agitation in order to remove the water content. The mixture was confirmed to be substantially free of both free-DMA and water by analysing a sample.

Results

DEA v DMA with TPGDA

For TPGDA (a given α,β-unsaturated ester) one can compare the effect on the adduct properties of using DEA as the amine (following the method described Comp A) with each of the Generic Examples I to III which use a different source of DMA as the amine. With TPGDA the following is observed (although these effects are independent of the α,β-unsaturated ester as is shown below)

### Comp 1 and Example 1 (TPGDA & DEA v TPGDA & Dimcarb)

While several hours are needed to attain 80-85% in double bond conversion at 53.5° C. when DEA is used, the addition of Dimcarb is virtually complete (100% conversion) at the end of the elimination and a maturation step is no longer necessary.

While several hours further processing are required to decrease the residual DEA level below 200 ppm, with Dimcarb a level of 350 ppm of free DMA was measured at the end of the elimination without further removal steps. A further step is still needed to get rid of CO₂ generated by the process for Dimcarb, but nevertheless such further step(s) are found to be far shorter than those further process steps required with DEA. For example in the Dimcarb process (Generic Process I) subjecting the reaction vessel to a pressure of 100 mmHg for less than one hour was found to decrease the CO₂ content from 3-4% down to 0.1%. Similar results can be obtained with a high-speed agitation. These observations indicate that the processing time decreases by a factor of between 2 to 3 when using Dimcarb as the amine compared to the analogous process using DEA.

### Examples 2 and 3

TPGDA was also aminated with g-DMA and DMA60 as described respectively in Generic Examples II and III herein and as with Dimcarb, complete disappearance of double bonds was observed at the end of the elimination.

It was found that use of g-DMA, Dimcarb and DMA60 as the source of DMA resulted in approximately the same rate of conversion of α,β-unsaturated ester to adduct.

Thus without wishing to be bound by any mechanism it is believed that the improved kinetics of double bond conversion is due to the higher nucleophilicity of DMA[(δ₂-)_{DMA}>(δ₂-)_{DEA}] and not due to matrix effects such as a presumed catalytic effect Of CO₂. This is consistent with the following evidence:

In order to better understand the respective roles of the methyl substituents the presence of CO₂, and the influence of the physical state of the DMA on the dramatically increased reactivity with acrylate double bonds it was determined that adding CO₂ whilst aminating with g-DMA under pressure does not lead to any significant effect on conversion rate. The (solid) complex of DEA with CO₂ (DEA.CO₂) was prepared and used to aminate TPGDA and the same rate of conversion to the adduct as with free DEA was observed.

Multifunctional (meth)acrylates

### Examples 4 to 18 and Comp 2 to 6

Using the same procedure described in the Comp A and Generic Examples I to III herein , acrylates with increasing functionalities were aminated with DEA, Dimcarb, g-DMA, and DMA60 respectively. Table 1 below shows percentage conversion level of ester into adduct at the end of elimination at room temperature for the following α,β-unsaturated esters:

polypropylene glycol diacrylates with two different chain lengths: PPG265DA and PPG425DA;

ethoxylated/propoxylated penthaerythritol triacrylate (that available commercially from UCB Chemicals under the trade mark Ebecryl 160);

ethoxylated trimethylolpropane tetracrylate (that available commercially from UCB Chemicals under the trade mark Ebecryl 40); and

dipentaerythritol hexaacrylate (DPHA—available commercially from UCB Chemicals).

TABLE 1

| | PPG- | PPG- | | | |
|---|---|---|---|---|---|
| | 265DA | 425DA | Eb160 | Eb40 | DPHA |
| Dimcarb | 100% | 100% | 95% | 97% | 100% |
| Ex 4 to 8 | (Ex 4) | (Ex 5) | (Ex 6) | (Ex 7) | (Ex 8) |
| DMA60 | 100% | 100% | 93% | 100% | 100% |
| Ex 9 to 13 | (Ex 9) | (Ex 10) | (Ex 11) | (Ex 12) | (Ex 13) |
| g-DMA | 100% | 100% | 100% | 100% | 100% |
| Ex 14 to | (Ex 14) | (Ex 15) | (Ex 16) | (Ex 17) | (Ex 18) |
| 18 | | | | | |
| DEA | 75% | 85% | 63% | 82% | 80% |
| (Comp 2 | (Comp 2) | (Comp 3) | (Comp 4) | (Comp 5) | (Comp 6) |
| to 6) | | | | | |

The same trends as with TPGDA have been observed. The structure of the moiety bearing the acrylate double bonds or the acrylate functionality does not seem to have any effect on conversion rate.

Amination of Other α,β-Unsaturated Esters

### Examples 19 to 20 and Comp 7 to 9

In order to see if the above observations are also true for other α,β-unsaturated esters, a methacrylate (PEG200DMA available commercially from UCB Chemicals) and a crotonate (ethyl crotonate available commercially as a pure compound from Aldrich) were aminated with DEA or Dimcarb. (both available commercially from UCB Chemicals). Table 2 below compares the double bond conversion levels (%)at the end of the elimination at room temperature for esters of Formula 1 where R⁵ is methyl and R¹ to R³ are as given in Table 2.

TABLE 2

| | Methacrylate | | | | Crotonate | |
|---|---|---|---|---|---|---|
| | (R¹═R²═H, | | Acrylate | | (R¹═R³═H, | |
| | R³═CH₃) | | (R¹═R²═R³═H) | | R²═CH₃) | |
| Dimcarb | 75 | (Ex 19) | 100 | (Ex 20) | 60 | (Comp 7) |
| DEA | 0 | (Comp 8) | 80 | (Comp 9) | <5 | (Comp 10) |

Even where amination is not complete, improvements between use of DEA and DMA were observed with acrylates and especially methacrylates.

Photoactivator Efficiency

The DMA/TPGDA adducts have been compared to DEA/TPGDA adduct (those available from UCB Chemicals under the trade designation P115) as coactivators in typical UV curable formulations:

The FIGS. 1 to 3 herein show cure speeds versus adduct concentration obtained for the coatings prepared in the following Examples.

Polyester Acrylate-Based Formulations (Section 1)

### Examples 21 to 38 and Comp 11 to 16

| | Relative amount |
|---|---|
| Ingredient | by weight. |
| Polyester acrylate available commercially | 35 |
| from UCB under the trade mark Ebecryl 810 | |
| 50:50 mixture of TPGDA and that triacrylate | 65 |
| available commercially from UCB.under the | |
| trade designation OTA480 | |
| Benzophenone (photoinitiator) | 5 |
| Silcone acrylate available commercially | 0.5 |
| from UCB under the trade mark Ebecryl 350 | |
| Amine | various (see Table |
| | 1 and FIG. 1) |

Various amines were used in the following examples and in different amounts as shown in Table 1 and FIG. 1. The above formulations were prepared by mixing the ingredients together in a mixer at 200 rpm. A film of 10 micron thickness was made from each of the above formulations and the film was coated onto paper and irradiated under a 80 W/cm G2M lamp. The curing speed of each example is also given in Table 1 and FIG. 1.

TABLE 1

| | | | Curing |
|---|---|---|---|
| Example | Amine | Amount | speed m/min |
| Comp 11 | DEA | 2 | 2 |
| Comp 12 | DEA | 5 | 15 |
| Comp 13 | DEA | 8 | 20 |
| Comp 14 | DEA | 10 | 25 |
| Comp 15 | DEA | 15 | 25 |
| Comp 16 | DEA | 20 | 25 |
| Ex 21 | Dimcarb | 2 | 5 |
| Ex 22 | Dimcarb | 5 | 20 |
| Ex 23 | Dimcarb | 8 | 30 |
| Ex 24 | Dimcarb | 10 | 30 |
| Ex 25 | Dimcarb | 15 | 25 |
| Ex 26 | Dimcarb | 20 | 25 |
| Ex 27 | g-DMA | 2 | 10 |
| Ex 28 | g-DMA | 5 | 20 |
| Ex 29 | g-DMA | 8 | 30 |
| Ex 30 | g-DMA | 10 | 25 |
| Ex 31 | g-DMA | 15 | 20 |
| Ex 32 | g-DMA | 20 | 20 |
| Ex 33 | DMA 60 | 2 | 5 |
| Ex 34 | DMA 60 | 5 | 20 |
| Ex 35 | DMA 60 | 8 | 30 |
| Ex 36 | DMA 60 | 10 | 30 |
| Ex 37 | DMA 60 | 15 | 20 |
| Ex 38 | DMA 60 | 20 | 15 |

Epoxy Acrylate-Based Formulations (Section 2)

### Examples 39 to 56 and Comp 17 to 22

| | Relative amount |
|---|---|
| Ingredient | by weight. |
| Epoxy acrylate available commercially | 15 |
| from UCB under the trade mark Ebecryl 600 | |
| TPGDA + OTA 480 (50:50) | 85 |
| Benzophenone (photoinitiator) | 5 |
| Ebecryl 350 | 0.5 |
| Amine/acrylate adduct | various |
| | (see Table 2 |
| | and FIG. 2) |

TABLE 2

| | | | Curing |
|---|---|---|---|
| Example | Amine | Amount | speed m/min |
| Comp 17 | DEA | 2 | 2 |
| Comp 18 | DEA | 5 | 15 |
| Comp 19 | DEA | 8 | 25 |
| Comp 20 | DEA | 10 | 30 |
| Comp 21 | DEA | 15 | 30 |
| Comp 22 | DEA | 20 | 25 |
| Ex 39 | Dimcarb | 2 | 5 |
| Ex 40 | Dimcarb | 5 | 20 |
| Ex 41 | Dimcarb | 8 | 30 |
| Ex 42 | Dimcarb | 10 | 30 |
| Ex 43 | Dimcarb | 15 | 25 |
| Ex 44 | Dimcarb | 20 | 25 |
| Ex 45 | g-DMA | 2 | 5 |
| Ex 46 | g-DMA | 5 | 20 |
| Ex 47 | g-DMA | 8 | 30 |
| Ex 48 | g-DMA | 10 | 25 |
| Ex 49 | g-DMA | 15 | 25 |
| Ex 50 | g-DMA | 20 | 20 |
| Ex 51 | DMA 60 | 2 | 10 |
| Ex 52 | DMA 60 | 5 | 25 |
| Ex 53 | DMA 60 | 8 | 30 |
| Ex 54 | DMA 60 | 10 | 30 |
| Ex 55 | DMA 60 | 15 | 25 |
| Ex 56 | DMA 60 | 20 | 20 |

Coatings using the above formulations were prepared as in described in Section 1 above using the amounts of the various amines given in Table 2 and FIG. 2. The curing speed of each formulation is also given in Table 2 and FIG. 2.

Urethane Acrylate-Based Formulations (Section 3)

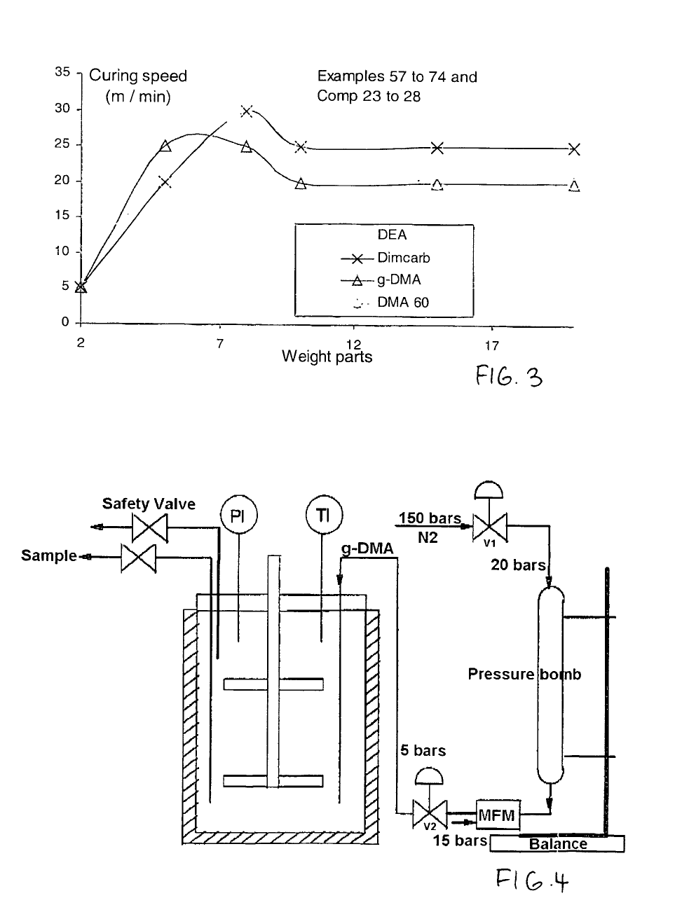

### Examples 57 to 74 and Comp 23 to 28

| | Relative amount |
|---|---|
| Ingredient | by weight |
| Urethane acrylate available commercially | 19 |
| from UCB under the trade mark Ebecryl 210 | |
| Epoxy acrylate available commercially | 19 |
| from UCB under the trade mark Ebecryl 605 | |
| TPGDA + OTA 480 (50:50) | 35 |
| 1,6-hexanediol diacrylate (HDDA) | 14 |
| Benzophenone (photoinitiator) | 5 |
| Ebecryl 350 | 0.5 |
| Amine | various (see Table |
| | 3 and FIG. 3) |

Coatings using the above formulations were prepared as in described in Section 1 above using the amounts of the various amines given in Table 3 and FIG. 3. The curing speed of each formulation is also given in Table 3 and FIG. 3.

TABLE 3

| | | | Curing |
|---|---|---|---|
| Example | Amine | Amount | speed m/min |
| Comp 23 | DEA | 2 | 5 |
| Comp 24 | DEA | 5 | 15 |
| Comp 25 | DEA | 8 | 20 |
| Comp 26 | DEA | 10 | 25 |
| Comp 27 | DEA | 15 | 25 |
| Comp 28 | DEA | 20 | 25 |
| Ex 57 | Dimcarb | 2 | 5 |
| Ex 58 | Dimcarb | 5 | 20 |
| Ex 59 | Dimcarb | 8 | 30 |
| Ex 60 | Dimcarb | 10 | 25 |
| Ex 61 | Dimcarb | 15 | 25 |
| Ex 62 | Dimcarb | 20 | 25 |
| Ex 63 | g-DMA | 2 | 5 |
| Ex 64 | g-DMA | 5 | 25 |
| Ex 65 | g-DMA | 8 | 25 |
| Ex 66 | g-DMA | 10 | 20 |
| Ex 67 | g-DMA | 15 | 20 |
| Ex 68 | g-DMA | 20 | 20 |
| Ex 69 | DMA 60 | 2 | 10 |
| Ex 70 | DMA 60 | 5 | 20 |
| Ex 71 | DMA 60 | 8 | 30 |
| Ex 72 | DMA 60 | 10 | 25 |
| Ex 73 | DMA 60 | 15 | 20 |
| Ex 74 | DMA 60 | 20 | 20 |

The following trends were observed. Whatever the DMA source used, less DMA-based product must be added. Higher curing efficiencies may be explained by higher amine contents in the DMA-based product and hence higher nitrogen (6.5 N % w/w for DMA/adducts compared to 5 N % w/w for the DEA adducts).

Odor of Products

Before curing the formulations were tested by a panel who agreed that the Dimcarb/TPGDA products were less odorous than a commercial available formation made from DEA (that available from UCB Chemicals under the trade designation P115).

Other Observations

No significant changes in gloss and photo-yellowing were observed when using DMA instead of DEA to prepare the adducts. Viscosities of DMA-based products lie within those of a conventional DEA product such as P115. Dimcarb-based products showed far better adhesion on an aluminium substrates.

Thus the applicant has found that use of DMA instead of DEA is advantageous to prepare the highly aminated amine (meth)acrylate adducts of the present invention for many reasons. Whatever its state (Dimcarb, DMA60 or g-DMA), a fully aminated product can be obtained almost instantaneously using DMA instead of DEA. No stripping of the amine is required. Stripping of CO₂ is however required when Dimcarb is used. The higher amine content achieved leads to better photoactivity for the DMA-based products. Using DMA as the amine is also cheaper compared to use of DEA as whatever the DMA state, savings can be made on raw material costs.

1. An amine/ester adduct formed between dimethylamine (DMA) and at least one optionally substituted α,β unsaturated ester obtained or obtainable by reacting a suitable acrylic or methacrylic acid with a suitable alcohol or polyol, characterised that said adduct has a level of amination above about 75%.

2. The adduct of claim 1, which is formed between a substantially stiochiometric ratio of DMA and the ester

3. An amine/ester adduct formed between a substantially stiochiometric ratio of dimethylamine (DMA) and at least one optionally substituted α,β unsaturated ester obtained or obtainable by reacting a suitable crotonoic acid with a suitable alcohol or polyol, characterised that said adduct has a level of amination above about 75%.

4. The adduct of any preceding claim, having a level of amination above about 90%

5. The adduct of claim 4, having a level of amination above about 95%

6. The adduct of claim 5, which is substantially completely aminated.

7. The adduct of any preceding claim, which is substantially free of free-amine optionally any amine present being present in an organoleptically undetectable amount.

8. The adduct of any preceding claim, which is substantially odour free.

9. The adduct of any preceding claim, which comprises less than about 10 ppm of free amine.

10. The adduct of any preceding claim, in which the ester is selected from the group consisting of: trimethylolpropane triacrylate (TMPTA), tripropylene glycol diacrylate (TPGDA), tetraethylene glycol diacrylate, 1,6-hexanediol diacrylate (HDDA), 1,3-butylene glycol diacrylate, 2-phenoxyethyl acrylate, trimethylolpropane trimethacrylate, polyethylene glycol dimethacrylate, tetraethylene glycol dimethacrylate; 1,3-butylene glycol dimethacrylate; polyether acrylates; polypropylene glycol diacrylates; ethoxylated/propoxylated penthaerythritol tetracrylate; dipentaerythritol hexaacrylate (DPHA);octyl/decyl acrylate, cyclic trimethylolpropane formal acrylate, isobornyl acrylate, dipropylene glycol diacrylate, tricyclodecane dimethanol diacrylate, ethoxylated trimethylolpropane triacrylate, propoxylated glycerol triacrylate, polypropylene glycol diacrylates, ditrimethylolpropane tetracrylate, ethoxylated/propoxylated pentaerythrytol tetracrylate, pentaerythrytol tetracrylate, dipentaerythritol hexaacrylate, octyl/decyl methacrylate, cyclic trimethylolpropane formal methacrylate, isobornyl methacrylate, dipropylene glycol dimethacrylate, 1,6-hexanediol dimethacrylate, 2-phenoxyethyl methacrylate, tricyclodecane dimethanol dimethacrylate, ethoxylated trimethylolpropane trimethacrylate, propoxylated glycerol trimethacrylate, polypropylene glycol dimethacrylates, ditrimethylolpropane tetramethacrylate, ethoxylated/propoxylated pentaerythrytol tetracrylate, pentaerythrytol tetramethacrylate, dipentaerythritol hexamethacrylate and effective combinations and/or mixtures thereof.

11. The adduct of any preceding claim, in which the alcohol or polyol is selected from the group consisting of: isoborneol, isoborneol, trimethylolpropane, cyclic trimethylolpropane formal, ditrimethylolpropane, dipropylene glycol, tricyclodecane dimethanol, ethoxylated trimethylolpropane, propoxylated glycerol, pentaerythrytol, ethoxylated/propoxylated pentaerythrytol, dipentaerythritol and effective combinations and/or mixtures thereof.

12. An adduct as described herein with reference to Examples 1 to 74 and FIGS. 1 to 4.

13. An process for preparing a substantially anhydrous, substantially amine free adduct comprising the steps of:
(a) reacting
(i) a source of dimethylamine (DMA) with
(ii) at least one optionally substituted α,β unsaturated ester obtained or obtainable by reacting a suitable acrylic or methacrylic acid with a suitable alcohol or polyol,
until amination is substantially complete; and
(c) treating the product(s) of step (a) to obtain an adduct substantially free of amine and/or water.

14. The process of any preceding claim, in which the DMA source is selected from the group consisting of: gaseous DMA, DMA dissolved in a solvent.

15. The process according to claim 14, in which the solvent for DMA is selected from water and liquid carbon dioxide.

16. The process according to claim 15, in which the DMA source comprises 60% DMA in water and/or 63% DMA in liquid CO₂.

17. An adduct obtained or obtainable from the process as claimed in any of claims 13 to 16.

18. A polymer obtained and/or obtainable by the radiation initiated polymerisation of at least one suitable polymer precursor, optional reactive diluent and an adduct as claimed in any of claims 1 to 12 and 17.

19. A polymer as claimed in claim 18, which is substantially odour free.

20. A polymer as claimed in claim 18 or 19, in which the polymer precursor is selected from the group consisting of: polyester acrylate oligomers, epoxy acrylate oligomers, urethane acrylate oligomers; and effective combinations and/or mixtures thereof.

21. A polymer as claimed in any of claims 18 to 20, in which the reactive diluent is non-optional and is selected from octyl/decyl acrylate, isobornyl acrylate, cyclic trimethylolpropane formal acrylate, 2-phenoxyethyl acrylate, N-butyl 2-(acryloxoloxy) ethyl carbamate, 1,6-hexanediol diacrylate, dipropylene glycol diacrylate, tripropylene glycol diacrylate, tetrapropylene glycol diacrylate, trimethylolpropane triacrylate, pentaerythrytol tetracrylate, propoxylated glycerol triacrylate, ethoxylated trimethylolpropane triacrylate, ethoxylated/propoxylated pentaerythrytol tetracrylate, dipentaerythritol hexamethacrylate and effective combinations and/or mixtures thereof.

22. A formulation which is UV curable and/or polymerisable and which comprises an adduct as claimed in any of claims 1 to 12 and 17.

23. Use of an adduct as claimed in any of claims 1 to 12 and 17 in a method of preparing the polymer as claimed in any of claims 18 to 21.

24. Use of an adduct as claimed in any of claims 1 to 12 and 17 as a polymer precursor, activator and/or reactive diluent for radiation induced polymerisation.

25. A substrate and/or article coated with and/or comprising an adduct as claimed in any of claims 1 to 12 and 17, a polymer as claimed in any of claims 18 to 21 and/or a formulation as claimed in claim 22.
